(19) United States
(12) Patent Application Publication
(10) Pub. No.: US 2013/0217396 A1
(43) Pub. Date: Aug. 22, 2013

(54) METHODS AND SYSTEMS FOR PROVIDING MOBILE-DEVICE ROAMING SERVICES

(71) Applicant: Maximilian Geffner, Littleton, CO (US)

(72) Inventor: Maximilian Geffner, Littleton, CO (US)

(73) Assignee: Global Mobile Corporation, Denver, CO (US)

(21) Appl. No.: 13/401,470

(22) Filed: Feb. 21, 2012

(51) Int. Cl. H04W 8/26; H04W 40/00

(52) U.S. Cl. 455/445

(57) ABSTRACT

Methods and systems are disclosed for routing a communication to a recipient mobile device. The communication is received at a switching center. The recipient mobile device is identified from the communication. Which of multiple identifiers of the recipient mobile device is active is identified. Each of the identifiers is uniquely assigned to the recipient mobile device, and each of the identifiers is associated with a mobile communications network. The active identifier was previously activated by one of the mobile communications networks that services a geographical area in which the recipient mobile device is physically present. That mobile communications network is identified from the active identifier. The communication is accordingly routed to the mobile communications network with instructions to further route the communication to the recipient mobile device.

### BACKGROUND OF THE INVENTION

This application relates generally to mobile-device services. More specifically, this application relates to methods and systems for providing roaming services for mobile devices.

As used herein, “mobile device” refers generally to any handheld device that makes use of wireless telecommunications services. It thus includes mobile telephones and smartphones, but may also include such devices as tablets computers, personal digital assistants, enterprise digital assistants, digital music players, among others.

One of the more significant costs that affects users of mobile devices are “roaming” fees, which are imposed as a result of needing to maintain connectivity service as the mobile device is moved into locations serviced by different networks without losing a connection. While the term “roaming” originates from terminology applied to GSM (“Global System for Mobile Communications”) standards, it is used more broadly herein to refer to any arrangement by which mobile connectivity service is maintained through the use of different networks that service different geographical areas.

The basic implementation of roaming services may be understood with reference to FIG. 1, which broadly shows the interaction of a mobile device 120 with a first network 104-1 (“Network A”) that services the geographical area in which the mobile device 120 is present (“the visited network”), and that is different than the “home” network 104-2 (“Network B”) with which the subscriber associated with the mobile device 120 originally contracted for services.

Under a traditional roaming arrangement, an agreement is established between operators of the home and visited networks in the form of a “roaming agreement” that provides for authentication of the mobile device 120, authorization to provide telecommunications services, and billing of the visiting subscriber. Information about the subscriber's contract for services with the home network 104-2 is generally stored in a home location register B 116-2 that is accessible by mobile network operator B 108-2. The visited network 104-1 has a similar arrangement, with a home location register A 116-1 that is accessible by mobile network operator A 108-1 and that stores information related to subscribers having contracts with the visited network 104-1.

When the mobile device 120 is activated in the geographical area served by the visited network 104-1, the network 104-1 identifies the presence of the mobile device 120, identifies that it is not registered with its own system, and attempts to identify the home network 104-2. If there is no roaming agreement between the two networks 104-1 and 104-2, maintenance of service is impossible and service is denied by the visited network 104-1. If there is a roaming agreement between the networks 104-1 and 104-2, however, the visited network 104-1 contacts the home network 104-2 and requests service information relevant to the particular mobile device 120, particularly including whether the contract associated with that mobile device 120 permits roaming services using an “international mobile subscriber identity” (“IMSI”) number. The IMSI is a unique identification known in the art that is stored as a 64-bit field in the subscriber-identity-module (“SIM”) card within the device. In addition to the assigned IMSI number, such SIM cards generally include security authentication and ciphering information, temporary information related to the local network, a list of services the subscriber has access to, and password information that is used for authentication with the relevant networks. The IMSI generally conforms to the E.212 Standard of the International Telecommunication Union, the entire disclosure of which is incorporated herein by reference for all purposes.

After successfully receiving information from the home network 104-2, the visited network 104-1 initiates a temporary subscriber record for the mobile device 120 its home location register A 116-1. In parallel, the home network 104-2 initiates an update of its home location register B 116-2 to indicate that the mobile device 120 is currently being serviced by the visited network 104-1, thereby enabling it to route information intended to be received by the mobile device 120 to the visited network 104-1.

Frequently, the fees charged to the subscriber for this use of the visited network are significantly in excess of the fees that would be paid for use of the home network.

### SUMMARY

Embodiments of the invention provide methods of routing a communication to a recipient mobile device. The communication is received at a switching center. The recipient mobile device is identified from the communication. Which of a plurality of identifiers of the recipient mobile device is active is identified. Each of the plurality of identifiers is uniquely assigned to the recipient mobile device, and each of the plurality of identifiers is associated with a respective one of a plurality of mobile communications networks. The active identifier was previously activated by a one of the plurality of mobile communications networks that services a geographical area in which the recipient mobile device is physically present. The one of the plurality of mobile communications networks is identified from the active identifier. The communication is accordingly routed to the one of the plurality of mobile communications networks with instructions to further route the communication to the recipient mobile device.

In some of these embodiments, the recipient mobile device comprises a mobile telephone and the communication comprises a mobile telephone call. The plurality of identifiers may comprise international mobile subscriber identities.

In some instances, a notification may be received from a second of the plurality of mobile communications networks that the recipient mobile device is physically present in a second geographical area different from the geographical area, with the second geographical area being serviced by a second of the plurality of mobile communications networks different from the one of the plurality of mobile communications networks. The active identifier is accordingly deactivated and a second of the plurality of identifiers is activated, specifically the identifier associated with the second of the plurality of mobile communications networks.

When a second communication is received at the switching center, the recipient mobile device is identified from the second communication and a determination is made that the second of the plurality of identifiers is active. The second of the plurality of mobile communications networks is accordingly identified from the second of the plurality of identifiers and the second communication is routed to the second of the plurality of mobile communications networks with instructions to further route the second communication to the recipient mobile device.

Each of the plurality of identifiers may be stored on a subscriber-identity-module card comprised by the recipient mobile device.

In another set of embodiments, a method is provided of activating one of a plurality of identifiers, with each of the plurality of identifiers being uniquely assigned to a mobile device. A notification is received from one of a plurality of mobile communications networks that the mobile device is physically present in a geographical area serviced by the one of the plurality of mobile communications networks. A second of the plurality of identifiers is deactivated, the second of the plurality of identifiers being associated with a second of the plurality of mobile communications networks different from the one of the plurality of mobile communications networks. The one of the plurality of identifiers is accordingly activated.

Methods of the invention may also be embodied in a system comprising a communications interface, a storage device, and a processor in communication with the communications interface and with the storage device. The plurality of identifiers are stored on the storage device and the processor has instructions to effect execution of the methods described above.

### BRIEF DESCRIPTION OF THE DRAWINGS

A further understanding of the nature and advantages of the present invention may be realized by reference to the remaining portions of the specification and the drawings, wherein like reference labels are used through the several drawings to refer to similar components. In some instances, reference labels are followed with a hyphenated sublabel; reference to only the primary portion of the label is intended to refer collectively to all reference labels that have the same primary label but different sublabels.

FIG. 1 is a graphical illustration of a telecommunications architecture used in the prior art to provide roaming services to mobile-device subscribers;

FIG. 2 is a graphical illustration of a telecommunications architecture used in embodiments of the invention to provide roaming services to mobile-device subscribers;

FIG. 3 is a graphical illustration of another telecommunications architecture used in embodiments of the invention to provide roaming services to mobile-device subscribers;

FIG. 4 is a flow diagram summarizing methods of registering a mobile device in accordance with embodiments of the invention;

FIG. 5 is a flow diagram summarizing methods of routing a call to a mobile device in accordance with embodiments of the invention; and

FIG. 6 is a schematic illustration of a structure of a computational system on which methods of the invention may be embodied.

### DETAILED DESCRIPTION OF EXEMPLARY EMBODIMENTS

Embodiments of the invention provide telecommunications services to mobile-device subscribers that duplicate the functionality of traditional roaming arrangements. In some embodiments, this is achieved without triggering roaming fees even as the mobile device is moved to geographical locations being served by different networks.

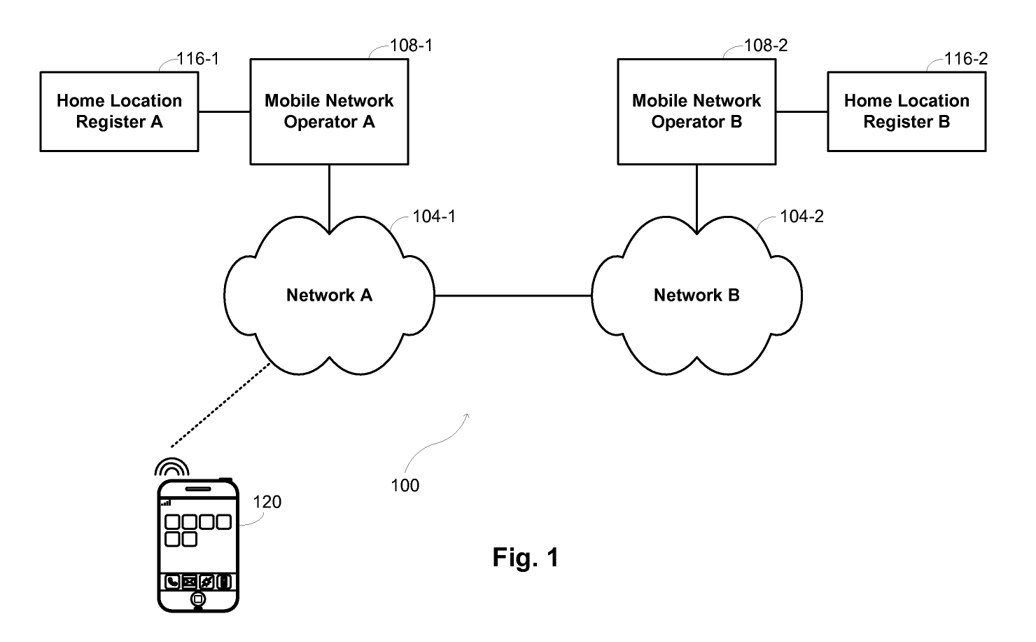

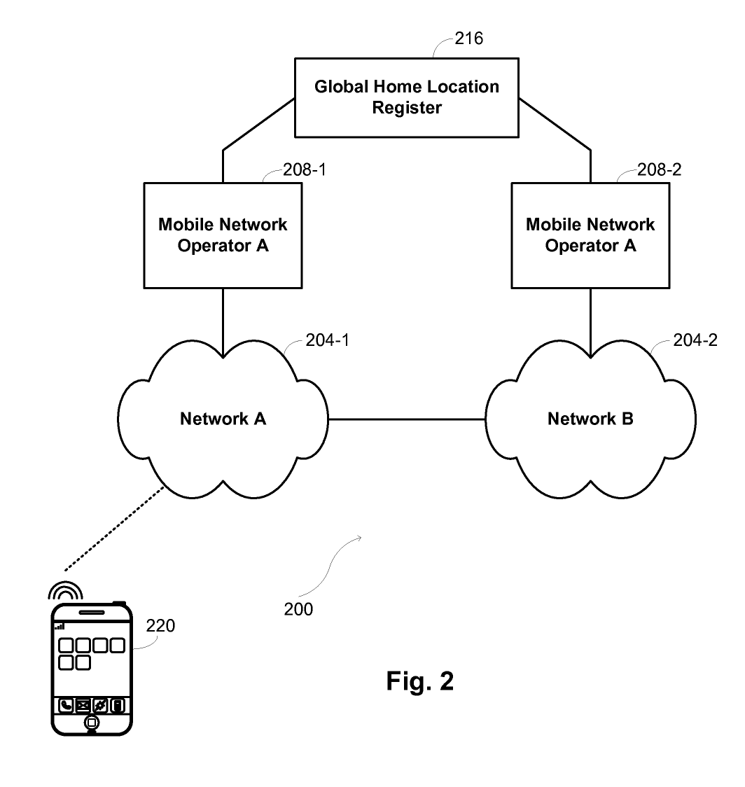

A general overview of a telecommunications architecture according to embodiments of the invention is illustrated with FIG. 2. This architecture bears considerable similarity to the prior-art architecture 100 of FIG. 1, enabling it to be implemented with relatively little disturbance to existing mobile-device telecommunications architectures. Specifically, the architecture 200 includes a plurality of networks 204, each of which is operated by a respective mobile network operator 208. The specific network 204 with which a particular mobile device 220 interacts is dictated primarily by its geographical location, although there are embodiments in certain geographical locations may be serviced by multiple networks.

Each of the mobile network operators 208 has access to a common global home location register 216 that maintains information related to subscribers and authorized mobile devices 220. Rather than each mobile device 220 having a SIM card that identifies only a single IMSI, mobile devices 220 may instead include multiple IMSIs or similar identifiers, records of which are maintained by the global home location register 216. Such a multi-IMSI feature enables a single mobile device 220 to take advantage of different (local) agreements with mobile network operators 208. As the mobile device 220 is moved to different geographical locations, the relevant IMSI used in accessing services changes, simplifying both the administrative mechanics that are used in providing services. In effect, a mobile-device subscriber has contractual agreements for services with a plurality of mobile network operators that avoids the need to make use of roaming agreements established between mobile network operators, which may result in more cost-effective agreements.

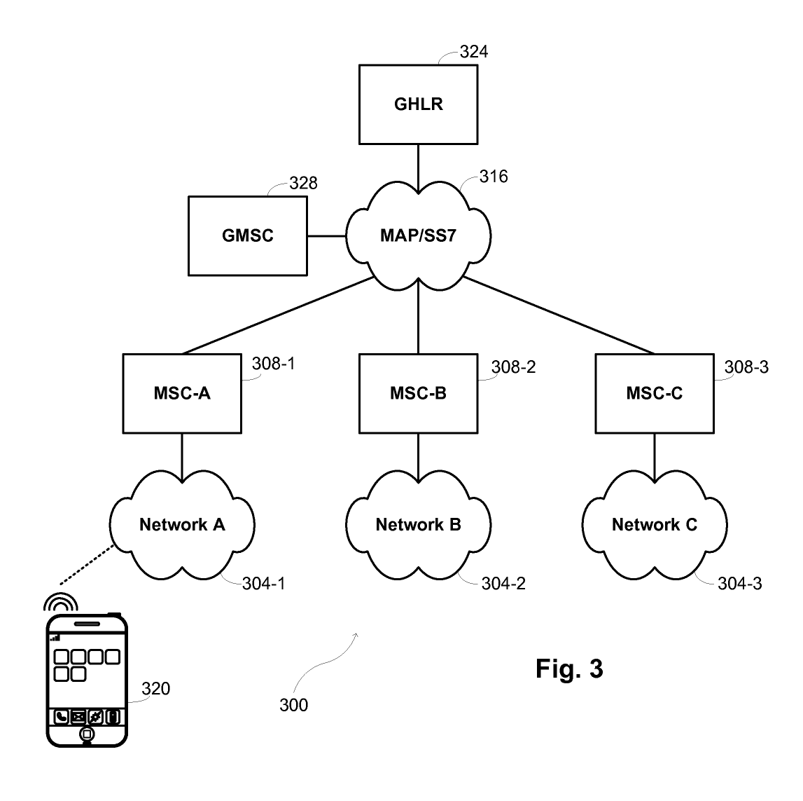

A more specific implementation is illustrated in FIG. 3, which shows an architecture 300 having a plurality of networks 304, each of which may, for instance, provide mobile-device services in different countries. Each of the networks 304 is operated by a respective mobile switching center 308 that communicates with a global mobile switching center 328 and a global home location register 324 through network 316.

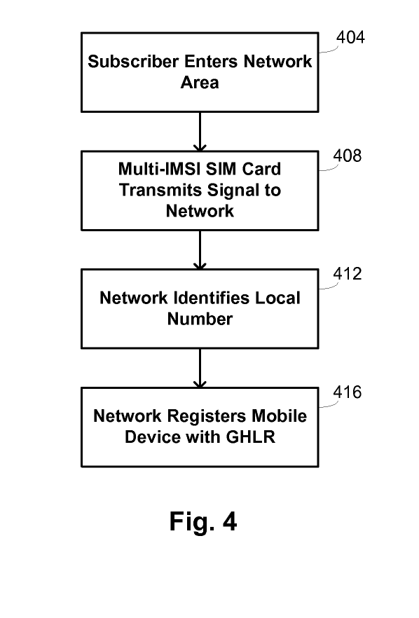

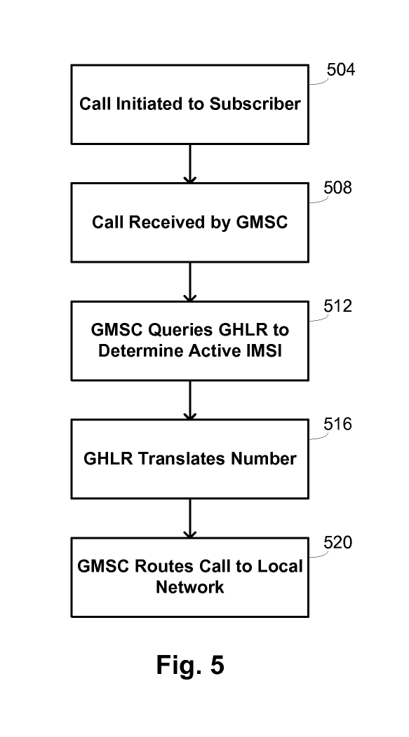

Operation of architectures such as those illustrated in FIGS. 2 and 3 is summarized with the flow diagrams of FIGS. 4 and 5. At block 404 of FIG. 4, for example, a subscriber enters a geographical are serviced by a local network with his mobile device, the detection of which by the network initiates transmission of a signal from the multi-IMSI SIM card comprised by the mobile device to the network at block 408. From the information received by the network, the specific IMSI assigned to the local network is identified at block 412, with the network then registering that mobile device with the global home location register at block 416.

What this methodology effects is an identification of the mobile device with the local network in accordance with a service arrangement between the subscriber and the local mobile service operator. Because the service arrangement is a local arrangement, roaming protocols and associated fees do not apply. When the mobile device is moved out of the geographical area into an area serviced by a different network, the same procedure illustrated in FIG. 4 is repeated with the new network, resulting in the registration of the mobile device with the new network using another of the multiple IMSI's maintain by its SIM card. Because the service arrangement between the new network and the mobile device is again a local arrangement, roaming protocols and associated fees do not apply.

The routing of calls to the mobile device (or of other types of data, such as a short-message-service (“SMS”) or other communication) in such an arrangement is illustrated with FIG. 5. While the drawing illustrates the handling of an incoming call initiated to the subscriber, as indicated at block 504, the same principles apply to the handling of an outgoing call. When the incoming call to the mobile device is received by the global mobile switching center 328 at block 508, the global mobile switching center queries the global home location register 324 at block 512 to determine which of the multiple IMSIs is currently active. This is a straightforward matter of querying a database that has been updated at block 416 of FIG. 4 each time the mobile device is moved to a geographical area serviced by a different network. The global home location register 324 translates the number at block 516 so that the call can be routed to the local network at block 520.

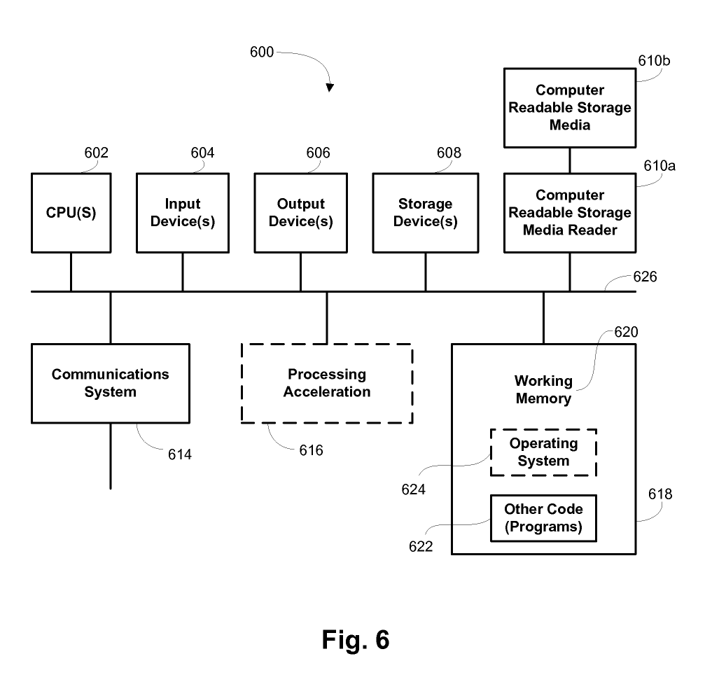

FIG. 6 is a block diagram illustrating a computational unit on which embodiments of the invention may be implemented. This example illustrates a system 600 that can be used, in whole or in part or in combination with other elements not shown here to implement the global mobile switching center 328 and/or the mobile switching centers 308. The system 600 is shown comprised of hardware elements that are electrically coupled via bus 626, including a processor 602, an input device 604, an output device 606, a storage device 608, a computer-readable storage media reader 610a, a communications system 614, a processing acceleration unit 616 such as a DSP or special-purpose processor, and a memory 618. The computer-readable storage media reader 610a is further connected to a computer-readable storage medium 610b, the combination comprehensively representing remote, local, fixed, and/or removable storage devices plus storage media for temporarily and/or more permanently containing computer-readable information. The communications system 614 may comprise a wired, wireless, modem, and/or other type of interfacing connection and permits data to be exchanged with the various networks as described above.

The system 600 also comprises software elements, shown as being currently located within working memory 620, including by way of example but not limited to an operating system 624 and other code 622, such as a program designed to implement methods of the invention. It should be understood that operating system 624 can be considered optional and in some implementations code such as machine code implementing embodiments of the present invention can be executed directly by CPU 602 without reliance on an operating system. It will be apparent to those skilled in the art that substantial other variations may be made in accordance with specific requirements. For example, customized hardware might also be used and/or particular elements might be implemented in hardware, software (including portable software, such as applets), or both. Further, connection to other computing devices such as network input/output devices may be employed.

A number of variations of the described embodiments will be evident to those of skill in the art, some of which are described herein explicitly, although the spirit of the invention encompasses all such variations. For example, while the methods and systems described above avoid the application of roaming fees when each of the networks 304 is one directly accessible with the multi-IMSI SIM card, it remains possible for the mobile device to be used in geographical areas serviced by networks that are not part of the arrangement. In such instances, call routing proceeds in a manner similar to that described in connection with FIG. 1, with the advantage that there are effectively multiple home networks with which different roaming agreements may exist, each of such agreements having different terms. The subscriber benefits from the ability of the system thus to select which roaming agreement is most advantageous and to route communications through the corresponding home network. This results in a lower overall cost for use of the mobile device in geographical areas serviced only by nonparticipating networks that might be achieved with the prior art.

More generally, the system may assign preferred roaming partners based on these different arrangements that allows a dynamic and preferential selection of roaming partners when the mobile device is in a geographical area where the system has multiple roaming agreements. Such dynamic assignment of a roaming network may be based on such criteria as cost for the service, time the service is being requested, and the like.

In other variations, the system provides a “local number pool” that allows for the temporary allocation of a local IMSI to a roaming subscriber who does not have a local IMSI. When such a subscriber registers, the global home location register 324 informs the global mobile switching center 328 so that the subscriber may be assigned an IMSI from a pool of temporary IMSIs, provisioning the IMSI in the global home location register 324 and in the mobile device's SIM card. The subscriber then re-registers using the temporary IMSI so that telecommunications service may be provided as described above. This variation enables the reuse of temporary IMSIs, thereby reducing the range of numbers required to offer the multi-IMSI service to certain subscribers, particularly to non-frequent travelers. In addition, performing the detection in the global home location register 324 avoids the need to update every SIM card each time there is a change in the network architecture.

Embodiments of the invention also allow for proxy voice and SMS services, thereby enabling the multi-IMSI functionality to subscribers on other networks. The global home location register 324 appears as a virtual visitor location register to the host home location register and serves as the home location register for the subscriber when using the alternate IMSI. When the subscriber receives a call to his main number, the home location register requests the mobile station roaming number from the virtual visitor location register.

In still other variations, dual GLM and wi-fi authentication may be implemented, allowing subscribers to be authenticated in both GSM and wi-fi networks using SIM cards. A single subscriber can thus be provisioned with a SIM card that applies to the GSM architectures as well as to wi-fi architectures. Seamless interworking between these different networks may also be effected, thereby allowing a single dual-mode GSM/wi-fi mobile terminal to allow a subscriber to roam between the two networks.

Having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

What is claimed:

1. A method of routing a communication to a recipient mobile device, the method comprising:
receiving the communication at a switching center;
identifying the recipient mobile device from the communication;
determining which of a plurality of identifiers of the recipient mobile device is active, wherein:
each of the plurality of identifiers is uniquely assigned to the recipient mobile device;
each of the plurality of identifiers is associated with a respective one of a plurality of mobile communications networks; and
the active identifier was previously activated by a one of the plurality of mobile communications networks that services a geographical area in which the recipient mobile device is physically present;
identifying the one of the plurality of mobile communications networks from the active identifier; and
routing the communication to the one of the plurality of mobile communications networks with instructions to further route the communication to the recipient mobile device.

2. The method recited in claim 1 wherein the communication comprises a mobile telephone call.

3. The method recited in claim 1 wherein the recipient mobile device comprises a mobile telephone.

4. The method recited in claim 1 wherein the plurality of identifiers comprise international mobile subscriber identities.

5. The method recited in claim 1 further comprising:
receiving a notification from a second of the plurality of mobile communications networks that the recipient mobile device is physically present in a second geographical area different from the geographical area, wherein the second geographical area is serviced by a second of the plurality of mobile communications networks different from the one of the plurality of mobile communications networks;
deactivating the active identifier; and
activating a second of the plurality of identifiers, wherein the second of the plurality of identifiers is associated with the second of the plurality of mobile communications networks.

6. The method recited in claim 5 further comprising:
receiving a second communication at the switching center;
identifying the recipient mobile device from the second communication;
determining that the second of the plurality of identifiers is active;
identifying the second of the plurality of mobile communications networks from the second of the plurality of identifiers; and
routing the second communication to the second of the plurality of mobile communications networks with instructions to further route the second communication to the recipient mobile device.

7. The method recited in claim 1 wherein each of the plurality of identifiers is stored on a subscriber-identity-module card comprised by the recipient mobile device.

8. A method of activating one of a plurality of identifiers, wherein each of the plurality of identifiers is uniquely assigned to a mobile device, the method comprising:
receiving a notification from one of a plurality of mobile communications networks that the mobile device is physically present in a geographical area serviced by the one of the plurality of mobile communications networks;
deactivating a second of the plurality of identifiers, wherein the second of the plurality of identifiers is associated with a second of the plurality of mobile communications networks different from the one of the plurality of mobile communications networks; and
activating the one of the plurality of identifiers.

9. The method recited in claim 8 wherein the mobile device comprises a mobile telephone.

10. The method recited in claim 8 wherein the plurality of identifiers comprise international mobile subscriber identities.

11. A system for routing a communication to a recipient mobile device, the system comprising:
a communications interface;
a storage device; and
a processor in communication with the communications interface and with the storage device, the processor comprising:
instructions to receive the communication over the communications interface;
instructions to identify the recipient mobile device from the communication;
instructions to determining which of a plurality of identifiers of the recipient mobile device is active, wherein:
the plurality of identifiers are stored on the storage device;
each of the plurality of identifiers is uniquely assigned to the recipient mobile device;
each of the plurality of identifies is associated with a respective one of a plurality of mobile communications networks; and
the active identifier was previously activated by a one of the plurality of mobile communications networks that services a geographical area in which the recipient mobile device is physically present;
instructions to identify the one of the plurality of mobile communications networks from the active identifier; and
instructions to route the communication via the communications interface to the one of the plurality of mobile communications networks with instructions to further route the communication to the recipient mobile device.

12. The system recited in claim 11 wherein the communication comprises a mobile telephone call.

13. The system recited in claim 11 wherein the recipient mobile device comprises a mobile telephone.

14. The system recited in claim 11 wherein the plurality of identifiers comprise international mobile subscriber identities.

15. The system recited in claim 11 wherein the processor further comprises:
instructions to receive a notification via the communications interface from a second of the plurality of mobile communications networks that the recipient mobile device is physically present in a second geographical area different from the geographical area, wherein the second geographical area is serviced by a second of the plurality of mobile communications networks different from the one of the plurality of mobile communications networks;
instructions to deactivate the active identifier; and
instructions to activate a second of the plurality of identifiers, wherein the second of the plurality of identifiers is associated with the second of the plurality of mobile communications networks.

16. The system recited in claim 15 wherein the processor further comprises:
instructions to receive a second communication over the communications interface;
instructions to identify the recipient mobile device from the second communication;
instructions to determine that the second of the plurality of identifiers is active;
instructions to identify the second of the plurality of mobile communications networks from the second of the plurality of identifiers; and
instructions to route the second communication via the communications interface to the second of the plurality of mobile communications networks with instructions to further route the second communication to the recipient mobile device.
